(19) United States
(12) Patent Application Publication
(10) Pub. No.: US 2018/0015977 A1
(43) Pub. Date: Jan. 18, 2018

(54) ILLUMINATION DEVICE FOR A VEHICLE AND METHOD

(71) Applicant: Green Ride Ltd., Haifa (IL)

(72) Inventors: Ori YEMINI, Elyakhin (IL); Doobie ABRAHAM, Haifa (IL); Liran NAKACHE, Haifa (IL)

(73) Assignee: Green Ride Ltd., Haifa (IL)

(21) Appl. No.: 15/541,502

(22) PCT Filed: Jan. 6, 2016
(86) PCT No.: PCT/IL16/50010

§ 371 Date: Jul. 5, 2017

Related U.S. Application Data
(60) Provisional application No. 62/100,324, filed on Jan. 6, 2015.

(51) Int. Cl. B62J 6/20; B60Q 1/50; B62K 15/00; B62K 3/00

(52) U.S. Cl. CPC B62J 6/20; B60Q 1/50; B60Q 2400/50; B62K 15/006; B62K 3/002

(57) ABSTRACT

The disclosure is directed to an illumination device for a ground-riding vehicle where combination of location of non-rotating light and transparent portions' configuration of the hubcap are configured to form penumbra of a predetermined pattern on an area adjacent to the ground-riding vehicle, to a predetermined size.

### BACKGROUND

This disclosure is directed to a ground vehicle illumination device, specifically, to the disclosure is directed to an illumination device for a ground vehicle, the device configured to form penumbra of a predetermined pattern on the ground.

Under certain circumstances, various vehicles may incur and present dangers, and are for that reason equipped with lights to create a halo effect around the vehicle, warning other vehicles and pedestrians. However, in various conditions, such lights are often not sufficient as warning means.

It would therefore be advantageous to provide an additional system of lights to create an additional and unique safety measure as a warning signal. Such an additional system of lights may illuminate the ground and display thereon a penumbra having a predetermined pattern to better attract attention to the presence of the vehicle and mitigate possible accidents.

### SUMMARY OF THE DISCLOSURE

Disclosed, in various embodiments are illumination devices for a ground vehicle, the devices configured to form penumbra of a predetermined pattern on the ground.

In an embodiment, provided herein is an illumination device for a ground riding vehicle having at least one wheel assembly including a wheel rim coupled to and covered by a hubcap, the illumination device comprising: a first non-rotating light source located at a predetermined position relative to the wheel's rotation axis; and the hubcap, having transparent portions therein, wherein the combination of the location of the non-rotating light and the transparent portions of the hubcap are configured to form penumbra of a predetermined pattern on an area adjacent to the ground-riding vehicle.

In another embodiment, provided herein is a method of forming a predetermined penumbra on at least one side of one rotating wheel of a vehicle comprising: providing a wheel assembly comprising: a circular rim surrounded by a toroidal ring, the rim having at least one side covered with a hubcap having a continuous surface; and a light source; defining predetermined configuration of transparent portions on the continuous surface of the hubcap; and locating the light source located at a predetermined position relative to the axis of spinning of the wheel.

### BRIEF DESCRIPTION OF THE FIGURES

A better understanding of the illumination devices for a ground vehicle, the devices configured to form penumbra of a predetermined pattern on the ground, with regard to the embodiments thereof, reference is made to the accompanying drawings, in which like numerals designate corresponding elements or sections throughout and in which:

FIG. 1, illustrates a Y-Z cross-section of a simplified schematic embodiment of a wheel assembly W pertaining to a ground riding vehicle V, or vehicle V;

FIG. 2 illustrates embodiment of patterns created;

FIG. 3, illustrates an exploded view of an embodiment of the illumination device;

FIGS. 4 and 5, illustrate additional embodiments of configuration of transparent portions of the hubcap;

FIG. 6, illustrates a X-Y cross section of a simplified schematic embodiment of a wheel assembly W; and

FIGS. 7-9, illustrate embodiments of the penumbra formed at various combinations of light source location and hubcap transparent portions' configuration.

While the disclosure is amenable to various modifications and alternative forms, specifics thereof have been shown by way of example in the drawings and will be further described in detail below. It should be understood, however, that the intention is not to limit the disclosure to the particular embodiments described. On the contrary, the intention is to cover all modifications, equivalents, and reasonable alternatives.

### DETAILED DESCRIPTION

In several embodiments, provided herein are illumination devices for a ground vehicle, the devices configured to form penumbra of a predetermined pattern on the ground.

Accordingly and in an embodiment, provided herein is an illumination device for a ground riding vehicle having at least one wheel assembly including a wheel rim coupled to and covered by a hubcap. The illumination device (ID) can comprise a first non-rotating light source (in other words, a light source that maintains it position relative to the rotating circumference of the wheel), which can be located at a predetermined position relative to the wheel's rotation (or spin) axis. The illumination device can further comprise and be in communication with a hubcap, having transparent portions therein. In an embodiment, the combination of the predetermined positioning of the non-rotating light source and their communication with the transparent portions of the hubcap can be configured to form a penumbra of a predetermined pattern on an area adjacent to the ground-riding vehicle. The term “penumbra” refers in an embodiment to the partial shadow between the umbra and complete luminance, where part of the light source is visible (e.g., through the transparent portion of the hubcap), wherein the umbra generally refers to the substantially dark shadow cast by an object or portion of an object (e.g., the hubcap).

Furthermore, the term “hubcap” refers to wheel covers of the hubcap type as conventionally used in the vehicle industry. For example, various diameter hubcaps can be used, some of which cover only the central portion of the wheel axle while others extend outwardly on the rim of the tire closely adjacent to the tire itself. All hubcaps of conventional design can be used with the illumination devices described and claimed herein, and are meant to be included herein.

The illumination device can operate as a safety means for the mitigation of potential dangers facing vehicles and users of the transportation and road grid system. This aim is achieved in addition to existing lighting means, by the supply of an additional warning device, and method of providing visual warning lights, and of either static or dynamic illumination patterns on a ground portion adjacent the ground vehicle. Furthermore, the operation of the illumination device ID may be triggered and controlled either automatically or by a user.

Likewise, illumination device described may be used in various circumstances. For example, such a situation may arise when a user is stranded on a shoulder of a road with limited visibility. Illumination of the front, rear and sides of the vehicle and of the ground attracts the attention of other drivers and/or pedestrians and permits to discern people in the vicinity of the vehicle. Should the power supply of the vehicle fail, then, in an embodiment, a spare battery, may be used. It is noted that manually pushing a scooter comprising the illumination device described herein, will rotate the wheels and create an ever-changing dynamic pattern of light beams (a predetermined penumbra pattern) that will illuminate the ground.

As indicated, the hubcap(s) can have transparent portions therein. The transparent portions can be either openings in the continuous surface of the hubcaps, or a portion where the hubcap comprises a transparent section or part (e.g., a window). It should be noted that many designs can be used in the formation of the transparent portions, which can be used with the illumination devices described and claimed herein. The transparent portions cab for example, have a general shape of a horseshoe, or flower petal or other arcuate (or angular) designs.

Likewise, the light source can be coupled to the wheel axle in a way that will prevent its rotation with the wheel. For example, the light source can be a light emitting diode with, for example, intensity of between about 1200 and about 2400 lumens, mounted on an are operably coupled to a power source (e.g., battery, dynamo and the like) and a spindle coupled to the wheel axle assembly, such that while the wheel axle spins within the spindle, the light source coupled to the spindle remains at a constant height relative to the ground and constant orientation in terms of distance and angle from the yaw axis of the wheel.

In addition, the ground-riding vehicle having the illumination device described herein can be an automatically foldable, two-wheeled vehicle having a front wheel and a rear wheel. The automatically foldable, two wheeled vehicle (e.g., a motorized scooter), can be configured to automatically (in other words, without human intervention except actuating the folding), transition between an extended rideable position where the front wheel and the rear wheel are aligned along a longitudinal axis (rear wheel aligned behind the front wheel), and a folded stowed position wherein the front wheel and the rear wheel are concentrically parallel to each other along a transverse axis (in other words, parallel and next to each other while the wheels axis are at the same angle and height off the ground). The illumination devices described herein, can be configured to be operational only when light conditions require (in other words, during low visibility conditions), and upon transitioning between the extended rideable position and the folded stowed position and/or transitioning between the folded stowed position and the extended rideable position. It should be noted that using the combination of the location of the non-rotating light source and the transparent portions of the hubcap that are configured to form penumbra of a predetermined pattern on an area adjacent to the ground-riding vehicle in the illumination devices described herein can be configured to produce the predetermined penumbra only at limited upper RPM level. The upper RPM level will depend on the desired pattern, the size of the opening in the hubcaps and the light intensity. For example, the penumbra pattern can be formed at for example, between 1 and 20 RPM, or between about 2 RPM and about 15 RPM, specifically between about 3 RPM and 10 RPM or between about 2 RPM and about 6 RPM.

A more complete understanding of the components, processes, and devices associated with the illumination devices for a ground vehicle configured to form penumbra of a predetermined pattern on the ground adjacent to the vehicle (in other words, on either side front or back of the vehicle) disclosed herein, can be obtained by reference to the accompanying drawings. These figures (also referred to herein as “FIG.”) are merely schematic representations based on convenience and the ease of demonstrating the present disclosure, and are, therefore, not intended to indicate relative size and dimensions of the devices or components thereof and/or to define or limit the scope of the exemplary embodiments. Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

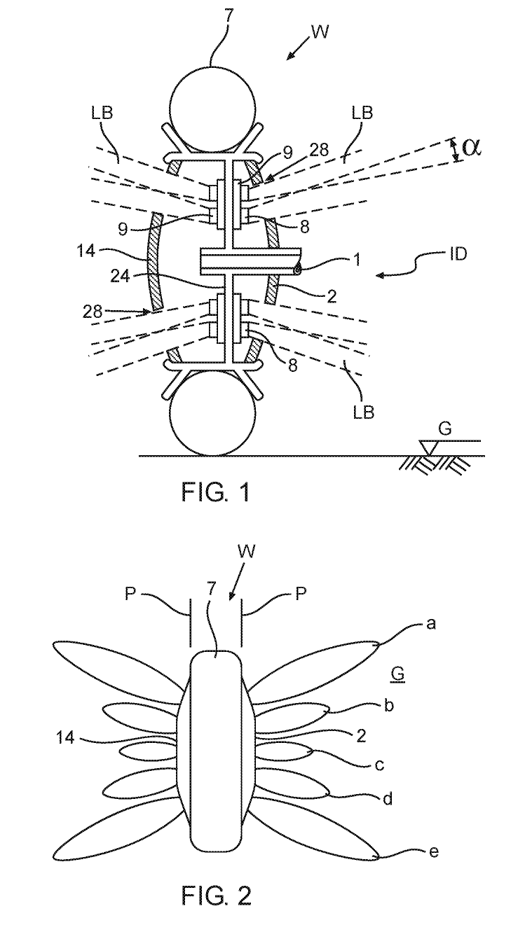

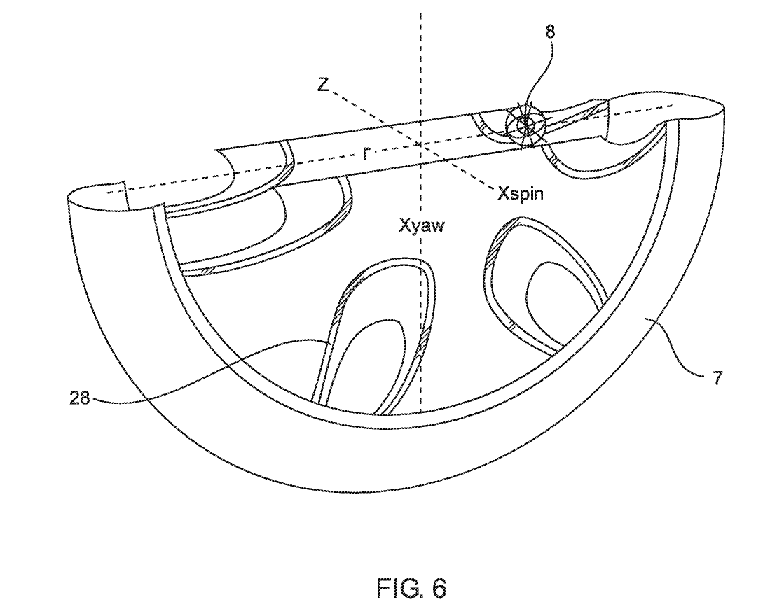

FIG. 1 illustrates an embodiment of the disposition of non-rotating light source 8 relative to sculptured (in other words, ornamentally detailed) hubcap transparent opening or portion 28. Light beam BL is emitted from transparent hubcap portion 28 at acute angle α relative to spin axle 1 (or Xspin, see e.g., FIG. 6). Thereby, light beam BL may be regarded as a directrix which, when rotated, generates a predetermined penumbra having the external surface of a truncated cone. The penumbra pattern formed on the ground G by light beam BL illustrates the intersection of the external surface of the truncated cone with the plane of the ground G.

Transparent hubcap portions 28 can generally have see-through clarity. The term “see-through clarity” refers in an embodiment to an easiness with which a light beam can be visible through transparent hubcap portion 28 and can be specified by total luminous transmittance and/or parallel luminous transmittance. As used herein, the see-through clarity becomes lower as the luminous transmittance decreases. “See-through” encompasses any characteristic that allows visual inspection through a wall. Specifically, a viewing window, or the entire wall may be translucent, transparent, or entirely clear. Thus, “translucent” indicates that light can pass through the layer, but the light is diffused. It does not require that a whole surface or hubcap 2 and/or 14 itself is transparent and that portions 28 of hubcap(s) 2, 14 may be transparent or opaque, for example to serve a function or to form a decorative/ornamental pattern. The term “translucent” as used herein would refer to a (resin) composition that transmits at least 60% in the region ranging from 290 nm to 780 nm with a haze of less than 40%. In one embodiment, the (e.g., thermoplastic) composition (e.g., poly(carbonate) its derivatives and copolymers) can have a transmission of at least 75%. In another embodiment, the (thermoplastic) composition can have a transmission of at least 85%. In yet another embodiment, the composition has a haze of less than 40%, and in another embodiment, the composition has a haze of less than 10%. In another embodiment, the composition has a haze of less than 5%, or specifically, less than 2%. Moreover, the term “transparent” refers in an embodiment to hubcap(s) 2, 14 composition capable of at least 70% transmission of light. Light source 9 referred to herein, can be, e.g., actinic light (e.g., from a laser), emitted light (e.g., from a fluorochrome), a light emitting diode, organic light emitting diode (OLED) or both, or transmittance of at least 80%, for example at least 85%, or at least 90%, for example, at least 95% or at least 98%, as measured spectrophotometrically using water as a standard (100% transmittance) at 690 nm Additionally, the term “transparent” as used herein would also refer to a (resin or silicon glass) composition that transmits at least 95% in the region ranging from 290 nm to 780 nm with a haze of less than 5%.

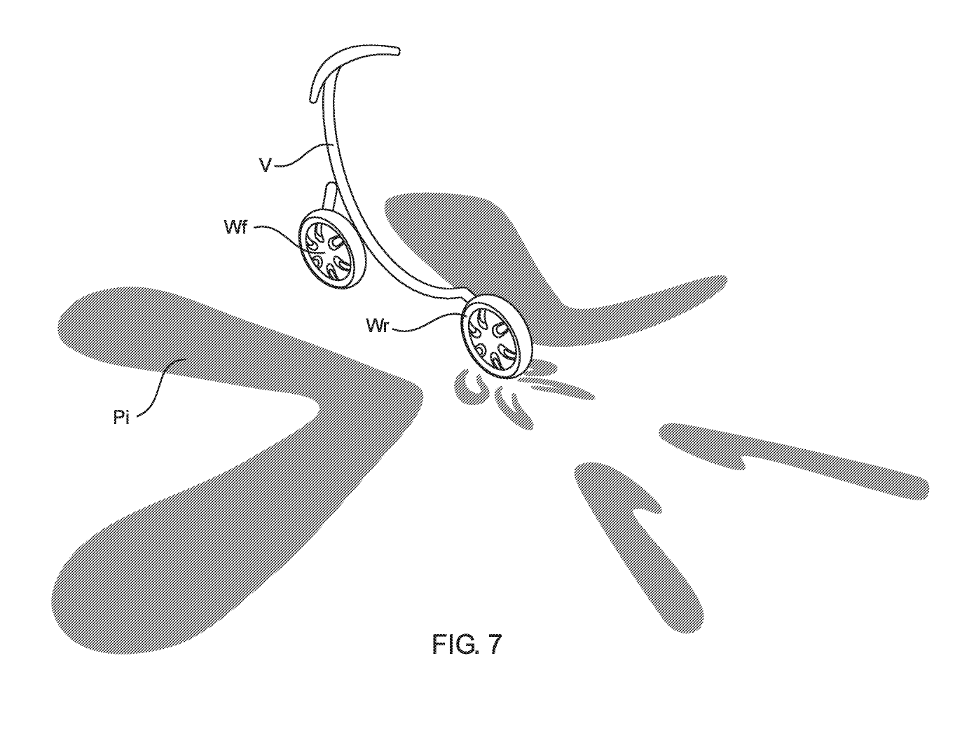

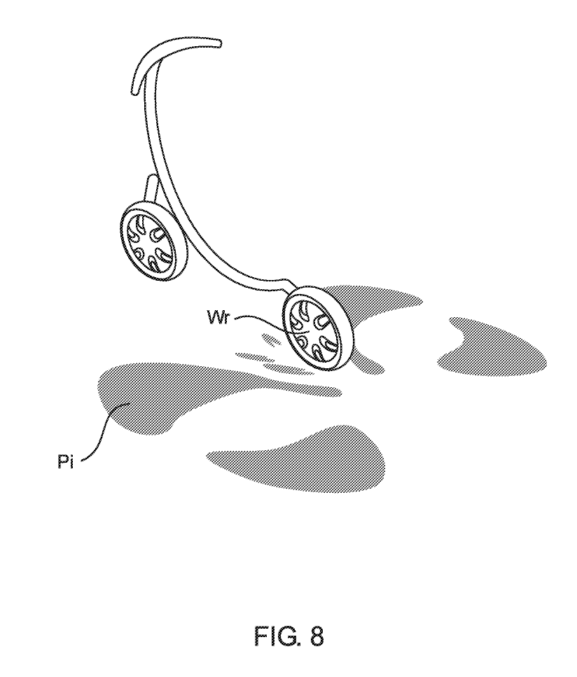

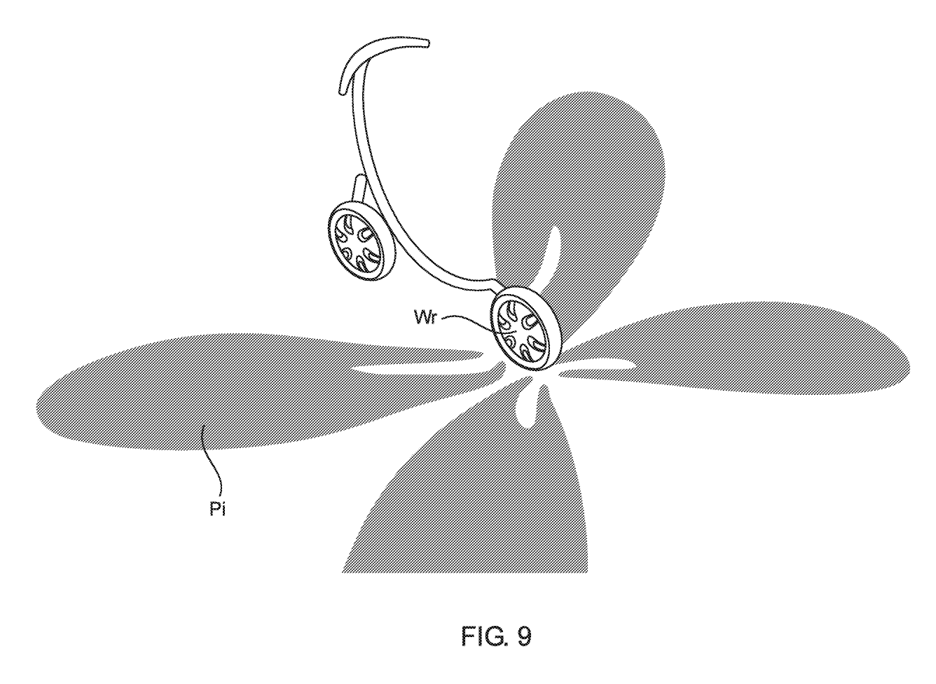

Accordingly and in an embodiment, provided herein is illumination device (ID) for ground riding vehicle V (see e.g., FIGS. 7-9) having at least one wheel assembly W (see e.g., FIG. 1) comprising wheel rim 5 operably coupled to; and covered by hubcap(s) 2, 14 (see e.g., FIGS. 1-3). As illustrated illumination device (ID) can further comprise first non-rotating light source 8 which can be located at a predetermined position relative to the wheel's rotation (or spin) axis (see e.g., FIG. 6). Illumination device (ID) can further comprise and be in communication with hubcap 2, 14, having transparent portions 28 therein. In an embodiment, the combination of the predetermined positioning (see e.g., FIGS. 1, 6) of non-rotating light source(s) 8 and their communication with transparent portions 28 of hubcap 2, 14 can be configured to form penumbra Pᵢ (see e.g., FIGS. 7-9) of a predetermined pattern on an area adjacent to the ground-riding vehicle V.

Returning to FIG. 1, wheel assembly W can have axle 1 coupled to wheel rim 5 which supports a tire 7 that may hold toroidal ring 6. One or two hubcap(s) 2 and 14 can cover rim 5 and enclose an interior volume 22 therebetween. Two support annuli 9 may be disposed one on each side of rim 5 wall 24 and be coupled thereto or to another non-rotating element (e.g., spindle 30, not shown) of wheel assembly W. Additionally, or alternatively, only one support annulus 9 may be used. Non-rotatable (first) light source 8, or plurality thereof that may be aligned (at a predetermined position as described) with the first non-rotating light source, may be disposed on one or both support annuli 9, on a surface facing away from the vehicle V. Non-rotatable light source 8 may include one or a plurality of light generating units 26 for example, LEDs (Light Emitting Diodes) of the same (monochromatic) or of different colors (full or partial spectrum), emitting light at any wavelength (i.e. monochromatic (e.g., between about 630 and 640 nm) or full/partial spectrum in between) between about 290 nm and about 780 nm.

As further illustrated in FIG. 1, power for light source 8 may be provided by a power supply disposed in vehicle V. An electric cable, (not shown), may maintain electric communication from the vehicle V through axle 1 (X_{Spin}, see e.g., FIG. 6); and to the illumination device ID, to provide the necessary power. Alternatively or additionally, power may be supplied to light source(s) 8 by a rechargeable battery (not shown), which may be disposed either on board vehicle V, for example, on front wheel W_{f} (see e.g., FIG. 7). The power supply for (first, second and other) light source(s) 8 may be either dependent or independent from the power supply of vehicle V.

Hubcaps 2 and 14 can comprise at least one sculptured, transparent hubcap portion 28, which can have see-through clarity for passage light beams LB emanating from non-rotatable light source 8. The term “sculptured” refers to the form, outline, or shape of transparent hubcap portion (s), or to their three dimensional structure that nay protrude out of, or be recessed below the surface of the hubcap(s) 2 and 14. The dimensions of sculptured transparent hubcap portion 28, in combination with the location of first, second or other light source(s) 8, can be one of the parameters that affect the predetermined penumbra pattern (see e.g., FIGS. 7-9). Light beams BL that radiate out of one or both hubcaps 2 and 14 may illuminate a portion of the ground G adjacent the vehicle V (see e.g., FIGS. 7-9).

Turning now to FIG. 2, schematically depicting a top elevation of a wheel assembly W disposed on ground G. As illustrated, wheel assembly W may pertain to a two-wheeled vehicle V and have wheel rim 5 supporting in an embodiment, first and second light sources 8, which can be configured to form a predetermined penumbra pattern on ground G on both sides of the wheel assembly W (see e.g., FIGS. 7-9). In FIG. 2, penumbra pattern PAT, created by, for example, five light beams BL on ground G on each side of wheel assembly W, are indicated from ‘a’ to ‘e’. Such a static pattern may be created for example, by wheel assembly W at standstill. However, when wheel assembly W is rotated, the penumbra pattern formed on the ground G becomes a dynamic scene.

For wheel assembly W in rotation, one may consider a unidirectional sweeping motion of formed penumbra pattern, in endless succession like an endless belt. In other words, the lit up shape ‘a’ replaces the lit up shape ‘b’, that ‘b’ replaces ‘c’, ‘c’ replaces ‘d’, and so on. Simultaneously, lit up shape ‘e’, takes the place of the now vacated lit up shape ‘a’ and so continues the endless sweep display formed by the light emission and the shadow formed by hubcaps 2, 14, through transparent hubcap portions 28.

Illumination device ID may further be used, for example, when a rider, say of a foldable electric scooter, desires enhanced protection when travelling in adverse visibility conditions such as at dusk, at night or in bad weather. Moreover, one may consider the case when for example an electric scooter is configured to automatically fold up to bring the front wheel assembly and the rear wheel assembly next to each other, or closer together when not in use, and to extend back to full length before a ride. In such a case, the illumination device ID may operate automatically, and provide warning of the event. It is noted that during folding of the scooter, narrowing the distance between front and rear wheel assembly will cause at least one wheel assembly W (e.g., Wᵣ, FIG. 7) to rotate by mere friction with the ground. Such a rotation, even as low as, for example, four RPM (Revolutions per Minute) can be configured to generate a vivid and highly visible dynamic penumbra pattern.

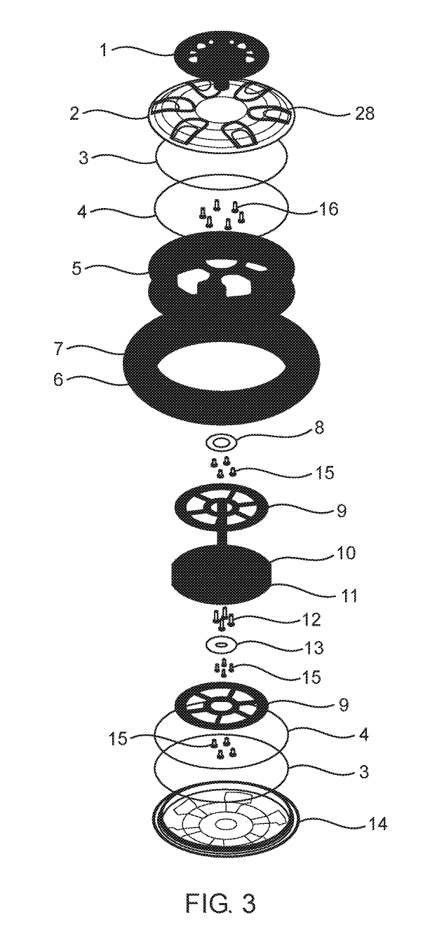

Turning now to FIG. 3, illustrating an exploded view of another embodiment of illumination device ID configured for example for use with wheel assembly W of a two-wheeled electric scooter. As illustrated, illumination device ID comprises at least one wheel assembly W comprising wheel rim 5 coupled to and covered by at least one hubcap 2, 14. Illumination device ID may have first light source 8 that can be coupled to the wheel rim and be generally non-rotatable. Hubcap(s) 2 (,14) may have at least one transparent hubcap portion 28 which can be configured for passage of light bean BL that emanates from light source(s) 8 (not shown, see e.g., FIG. 1, 6). Wheel assembly may further support two such hubcaps (2, 14), one on each side of wheel assembly W rim 5.

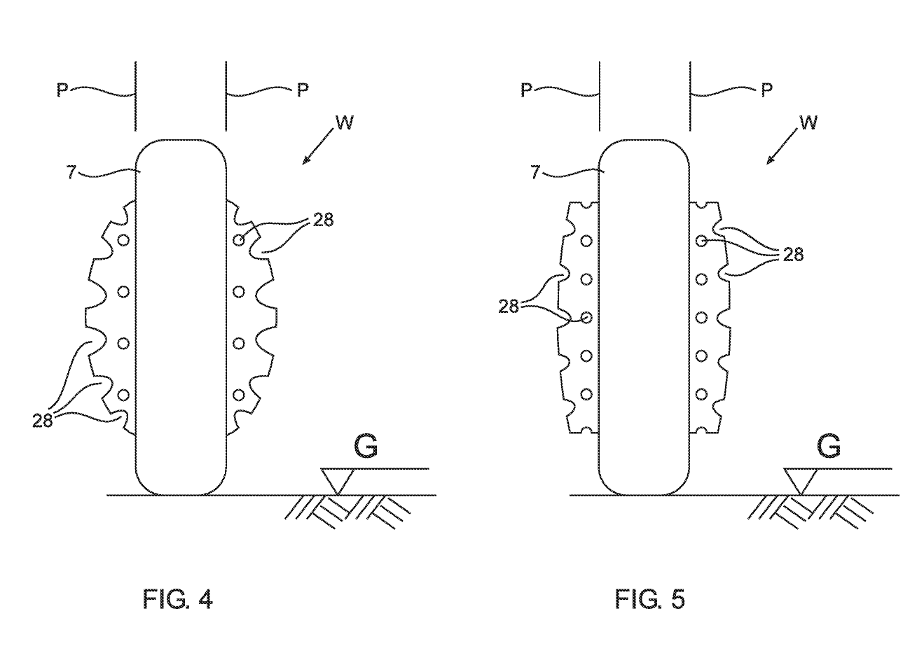

Turning now to FIGS. 4 and 5, further illustrating embodiments of hubcaps 2, and/or 14. FIGS. 4 and 5 depict hubcaps 2, 14, that may be configured to protrude out (in other words convex relative to wheel assembly W), of the plane P defined by the front side of wheel assembly W. Thereby, light emanating out of hubcaps 2, 14, may easily be seen from the front side or from the rear side of the vehicle, and not only from the side thereof. The predetermined penumbra formed can be configured to create the dynamic scene behind, in front of and to the sides of hubcaps 2, and/or 14, to a range of about 1.5 m. Hence, protruding hubcaps provide an additional safety signal, and furthermore, light exiting therefrom may be operated as a turn signal indicator. Further, wheel assembly W comprising the illumination devices described herein, can have a diameter (See e.g., FIG. 6) of between about 0.30 m (12 inch) and about 0.40 m (16 inch) and a width (see e.g., P, FIGS. 4, 5) of between about 0.04 m and about 0.15 m.

In an embodiment, since hubcaps 2, 14 can be configured to emit at least one beam of light, hubcaps 2, 14 may be considered as a sidelight configured to illuminate the side of the ground-riding vehicle for safety purpose. It is understood that transparent hubcap portions 28 can be sculptured with the aim to control, in combination with the eccentric non-rotatable location of light source(s) 8, at least the shape of the beam of light exiting transparent hubcap portion 28 and the penumbra pattern created on the ground.

Accordingly and in an embodiment, provided herein is a method of forming a predetermined penumbra on at least one side of one rotating wheel of a vehicle comprising: providing a wheel assembly comprising: a circular rim surrounded by a toroidal ring, the rim having at least one side covered with a hubcap having a continuous surface; and a light source; defining predetermined configuration of transparent portions on the continuous surface of the hubcap; and locating the light source at a predetermined position relative to the axis of spinning of the wheel. Toroidal ring 6, can be an inflated tube, a foam, a rubber, or the like. The toroidal ring can be described by any volume formed from the rotation of a revolving spheroid about a coplanar axis, where the radius of rotation of the symmetrical spheroid is larger than the major axis of the spheroid if an ovoid or the radius of the spheroid if a circle. The spheroid has to have to symmetrical axes one transverse to the other.

The term “communicate” (and its derivatives e.g., a first component “communicates with” or “is in communication with” a second component) and grammatical variations thereof are used to indicate a structural, functional, mechanical, electrical, optical, or fluidic relationship, or any combination thereof, between two or more components or elements. As such, the fact that one component is said to communicate with a second component is not intended to exclude the possibility that additional components can be present between, and/or operatively associated or engaged with, the first and second components. Furthermore, the term “electronic communication” means that one or more components of the folding handlebars having handles rotating along an angled plane of rotation (one in the Y-Z direction and the handles in the X-Y direction) and methods of folding the handles described herein are in wired or wireless communication or internet communication so that electronic signals and information can be exchanged between the components.

The term “coupled”, including its various forms such as“operably coupling”, “coupling” or “couplable”, refers to and comprises any direct or indirect, structural coupling, connection or attachment, or adaptation or capability for such a direct or indirect structural or operational coupling, connection or attachment, including integrally formed components and components which are coupled via or through another component or by the forming process. Indirect coupling may involve coupling through an intermediary member or adhesive, or abutting and otherwise resting against, whether frictionally or by separate means without any physical connection.

All ranges disclosed herein are inclusive of the endpoints, and the endpoints are independently combinable with each other (e.g., ranges of “up to 780 nm, or, more specifically, 630, 640 nm etc., is inclusive of the endpoints and all intermediate values of the ranges). “Combination” is inclusive of blends, mixtures, alloys, reaction products, and the like. Furthermore, the terms “first,” “second,” and the like, herein do not denote any order, quantity, or importance, but rather are used to denote one element from another.

The terms “a”, “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the hubcap(s) includes one or more hubcap). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

The term “selectably” means capable of being activated. In another embodiment, the term “selectably engage” is meant to indicate that the means for engaging the wrapping sheet can be activated if desired, but there is no specific requirement that engaging means is necessary for the operation of the machine. Other coupling/engaging means can also be used.

The term “about”, when used in the description of the technology and/or claims means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such and may include the end points of any range provided including, for example ±25%, or ±20%, specifically, ±15%, or ±10%, more specifically, ±5% of the indicated value of the disclosed amounts, sizes, formulations, parameters, and other quantities and characteristics.

Accordingly, provided herein is an illumination device for a ground riding vehicle having at least one wheel assembly comprising a wheel rim coupled to and covered by a hubcap, the illumination device comprising: a first non-rotating light source located at a predetermined position relative to the wheel's rotation axis; and the hubcap, having a transparent portions therein, wherein the combination of the location of the non-rotating light and the transparent portions of the hubcap are configured to form penumbra of a predetermined pattern on an area adjacent to the ground-riding vehicle, wherein (i) the wheel rim is covered by two hubcaps having transparent portions therein, (ii) further comprising a second non-rotating light source, aligned with the first non-rotating light source, wherein (iii) the combination of the location of the first non-rotating light and the transparent portions of the hubcap is configured to form the penumbra of a predetermined pattern toward the front, side, rear or a predetermined combination thereof, of the ground riding vehicle, wherein (iv) the first and/or second light source provides an intermittent light at intervals of between about 1 Hz and about 0.001 Hz, (v) the first light source is monochromatic, wherein (vi) the combination of the location of the first and/or second non-rotating light source(s) and the transparent portions of the hubcap is configured to form the penumbra of a predetermined pattern at a predetermined evolution per minute (RPM) of the wheel comprising the combination of the first non-rotating light and the hubcap having the transparent portions, (vii) at between about 2 and about 20 RPM, wherein (viii) the wheel has a diameter of between about 0.20 m (8 inch) and about 0.45 m (18 inch), for example, between 0.30 m (12 inch) and about 0.40 m (16 inch) and a width of between about 0.04 m and about 0.15 m, wherein (ix) the non-rotating first and/or second light source is located about parallel with the ground and at about 0.05 m and about 0.15 m away from the yaw axis of the wheel, wherein (x) the transparent portion in the hub cap is an arcuate slit, (xi) having a width of between about 1 mm and about 10 mm, wherein, (xii) the first and/or second light source is a monochromatic light emitting diode, emitting light at a wavelength of between about 630 nanometer (nm) and about 640 nm, wherein (xiii) the ground riding vehicle is an automatically foldable, two-wheeled vehicle having a front wheel and a rear wheel, configured to automatically transition between an extended rideable position where the front wheel and the rear wheel are aligned along a longitudinal axis, and a folded stowed position wherein the front wheel and the rear wheel are concentrically parallel to each other along a transverse axis, wherein (xiv) the illumination device is operational only upon transitioning between the extended rideable position and the folded stowed position and/or transitioning between the folded stowed position and the extended rideable position, and (xv) an automatically foldable motorized scooter comprising the illumination devices described herein.

In another embodiment, provided herein is a method of forming a predetermined penumbra on at least one side of one rotating wheel of a vehicle comprising: providing a wheel assembly comprising: a circular rim surrounded by a toroidal ring, the rim having at least one side covered with a hubcap having a continuous surface; and a light source; defining predetermined configuration of transparent portions on the continuous surface of the hubcap; and locating the light source at a predetermined position relative to the axis of spinning of the wheel, wherein (xvi) the wheel rim is covered by two hubcaps having transparent portions therein, (xvii) further comprising a second non-rotating light source, aligned with the first non-rotating light source, wherein (xviii) the first and/or second light source provides an intermittent light at intervals of between about 1 Hz and about 0.001 Hz, (xix) the first and/or second light source(s) is monochromatic, wherein (xx) the combination of the location of the first and/or second non-rotating light source(s) and the transparent portions of the hubcap(s) is configured to form the penumbra of a predetermined pattern at a predetermined evolution per minute (RPM) of the wheel comprising the combination of the first non-rotating light and the hubcap having the transparent portions, (xxi) at between about 2 and about 20 RPM, wherein (xxii) the wheel assembly has a diameter of between about 0.20 m (8 inch) and about 0.45 m (18 inch), for example, between 0.30 m (12 inch) and about 0.40 m (16 inch) and a width of between about 0.04 m and about 0.15 m, wherein (xxiii) the non-rotating first and/or second light source is located about parallel with the ground and at about 0.05 m and about 0.15 m away from the yaw axis of the wheel, wherein (xxiv) the transparent portion in the continuous surface of the hubcap is an arcuate slit, (xxv) having a width of between about 1 mm and about 10 mm, wherein, (xxvi) the first and/or second light source is a monochromatic light emitting diode, emitting light at a wavelength of between about 630 nm and about 640 nm, wherein (xxvii) the ground riding vehicle is an automatically foldable, two-wheeled vehicle having a front wheel and a rear wheel, configured to automatically transition between an extended rideable position where the front wheel and the rear wheel are aligned along a longitudinal axis, and a folded stowed position wherein the front wheel and the rear wheel are concentrically parallel to each other along a transverse axis, and wherein (xxviii) the illumination device is operational only upon transitioning between the extended rideable position and the folded stowed position and/or transitioning between the folded stowed position and the extended rideable position.

While particular embodiments have been described, alternatives, modifications, variations, improvements, and substantial equivalents that are or may be presently unforeseen may arise to applicants or others skilled in the art. Accordingly, the appended claims as filed and as they may be amended, are intended to embrace all such alternatives, modifications variations, improvements, and substantial equivalents.

1. An illumination device for a ground riding vehicle having at least one wheel assembly comprising a wheel rim coupled to and covered by a hubcap, the illumination device comprising:
a. a first non-rotating light source located at a predetermined position relative to the wheel's rotation axis; and
b. the hubcap, having a transparent portions therein,
wherein the combination of the location of the non-rotating light and the transparent portions of the hubcap are configured to form penumbra of a predetermined pattern on an area adjacent to the ground-riding vehicle.

2. The device of claim 1, wherein the wheel rim is covered by two hubcaps having transparent portions therein.

3. The device of claim 2, further comprising a second non-rotating light source, aligned with the first non-rotating light source.

4. The illumination device of claim 2, wherein the combination of the location of the first non-rotating light and the transparent portions of the hubcap is configured to form the penumbra of a predetermined pattern toward the front, side, rear or a predetermined combination thereof, of the ground riding vehicle.

5. The illumination device of claim 1, wherein the first light source provides an intermittent light.

6. The illumination device of claim 1, wherein the first light source is monochromatic.

7. The illumination device of claim 1, wherein the combination of the location of the first non-rotating light source and the transparent portions of the hubcap is configured to form the penumbra of a predetermined pattern at a predetermined evolution per minute (RPM) of the wheel comprising the combination of the first non-rotating light and the hubcap having the transparent portions.

8. The illumination device of claim 7, wherein the combination of the location of the first non-rotating light and the transparent portions of the hubcap is configured to form the penumbra of a predetermined pattern at between about 2 and about 20 RPM.

9. The illumination of device of claim 8, wherein the wheel has a diameter of between about 0.30 m (12 inch) and about 0.40 m (16 inch) and a width of between about 0.04 m and about 0.15 m

10. The illumination device of claim 1, wherein the first non-rotating light source is located about parallel with the ground and at about 0.05 m and about 0.15 m away from a yaw axis of the wheel.

11. The illumination device of claim 1, wherein the transparent portion in the hubcap is an arcuate slit.

12. The illumination device of claim 11, wherein the transparent slit has a width of between about 1 mm and about 10 mm.

13. The illumination device of claim 1, wherein the first light source is a monochromatic light emitting diode, emitting light at a wavelength of between about 630 nm and about 640 nm.

14. The illumination device of claim 1, wherein the ground riding vehicle is an automatically foldable, two-wheeled vehicle having a front wheel and a rear wheel, configured to automatically transition between an extended rideable position where the front wheel and the rear wheel are aligned along a longitudinal axis, and a folded stowed position wherein the front wheel and the rear wheel are concentrically parallel to each other along a transverse axis.

15. The illumination device of claim 14, wherein the illumination device is operational only upon transitioning between the extended rideable position and the folded stowed position and/or transitioning between the folded stowed position and the extended rideable position.

16. A foldable motorized scooter comprising the illumination device of claim 1.

17. A method of forming a predetermined penumbra on at least one side of one rotating wheel of a vehicle comprising:
a. providing a wheel assembly comprising: a circular rim surrounded by a toroidal ring, the rim having at least one side covered with a hubcap having a continuous surface; and a light source;
b. defining predetermined configuration of transparent portions on the continuous surface of the hubcap; and
c. locating the light source at a predetermined position relative to the axis of spinning of the wheel.

18. The method of claim 17, wherein the predetermined configuration of transparent portions on the continuous surface of the hubcap is configured to form the predetermined penumbra on the ground.

19. The method of claim 18, wherein the predetermined configuration of transparent portions on the continuous surface of the hubcap has the general shape of a horseshoe or a flower petal.

20. The method of claim 17, wherein the vehicle is an automatically foldable, two-wheeled vehicle having a front wheel and a rear wheel, configured to automatically transition between an extended rideable position where the front wheel and the rear wheel are aligned along a longitudinal axis, and a folded stowed position wherein the front wheel and the rear wheel are concentrically parallel to each other along a transverse axis.
